(19) United States
(12) Patent Application Publication
(10) Pub. No.: US 2020/0342770 A1
(43) Pub. Date: Oct. 29, 2020

(54) System and Program for Setting Flight Plan Route of Unmanned Aerial Vehicle

(71) Applicant: Autonomous Control Systems Laboratory Ltd., Chiba-shi, Chiba (JP)

(72) Inventor: Kenji Shinya, Chiba-shi, Chiba (JP)

(21) Appl. No.: 16/757,180

(22) PCT Filed: Oct. 17, 2017
(86) PCT No.: PCT/JP2017/037563

§ 371 Date: Apr. 17, 2020

(51) Int. Cl. G08G 5/00; G05D 1/00; G06F 16/29; B64C 39/02

(52) U.S. Cl. CPC G08G 5/0034; G08G 5/0039; G08G 5/0086; B64C 2201/127; G05D 1/0038; G06F 16/29; B64C 39/024; G08G 5/0069

(57) ABSTRACT

A 3D flight plan route is set based on an inputted scheduled flight route of an unmanned aerial vehicle. A system for setting a 3D flight plan route of an unmanned aerial vehicle according to the present invention is characterized by: inputting data indicating a scheduled flight route of the unmanned aerial vehicle on a horizontal plane; acquiring a height reference value indicating an elevation of a surface under each of a plurality of positions on the flight plan route; and determining values obtained by adding flight altitudes corresponding to the positions to the height reference values, respectively, as altitude data on the flight plan route.

### TECHNICAL FIELD

The present invention relates to a system for setting a flight plan route of an unmanned aerial vehicle and, more particularly, to a system for setting a 3D flight plan route based on an inputted scheduled flight route of an unmanned aerial vehicle.

### BACKGROUND ART

When a flight of an unmanned aerial vehicle is conducted, a flight plan is arranged by setting a 3D flight plan route of the unmanned aerial vehicle before the flight. For the setting, waypoints that are a plurality of positions defining the 3D flight plan route are inputted. In such a case, in general, X-, Y-coordinates that are positions of the waypoints on a horizontal plane are inputted by specifying the positions on a map, and Z-coordinates that are altitudes of the waypoints are inputted by inputting numerical values.

A Z-coordinate of a waypoint is commonly specified by a relative distance above a ground surface immediately under the waypoint, that is, an altitude above ground level. This agrees with a fact that an altitude limit of an unmanned aerial vehicle such as a drone is defined by using an altitude above ground level. When many waypoints are inputted, it can be time-consuming work to input an altitude above ground level of a waypoint, for each of the waypoints.

In some cases, a structure that can be an obstacle to a flight of an unmanned aerial vehicle, such as a tall building, exists on the ground surface. When an unmanned aerial vehicle flies over a place with such a structure, it is necessary to cause the unmanned aerial vehicle to climb and avoid collision, or to divert right or left for circumvention. To cause the unmanned aerial vehicle to appropriately climb, it is necessary to appropriately set waypoints in three dimensions, and to appropriately set altitudes above ground level of the waypoints. At the time, it is also necessary to carefully set the altitudes above ground level such that an altitude limit is not exceeded. When the unmanned aerial vehicle is caused to divert right or left for circumvention, it is necessary to appropriately set waypoints. In such a case, it is convenient if positional relationships of a 3D flight plan route with the ground surface and the structure are displayed in an easily perceived manner.

### SUMMARY OF INVENTION

### Technical Problem

However, no systems exist that, when a 3D flight plan route of an unmanned aerial vehicle is set, automatically set altitudes without needing inputs of the altitudes. No systems exist either that, in a case where a structure exists near a 3D flight plan route, display such a structure in an easily perceived manner when the 3D flight plan route is set. No systems exist either that, in a case where a structure exists near a 3D flight plan route, automatically set the 3D flight plan route that avoids such a structure when the 3D flight plan route is set.

### Solution to Problem

The present invention is made in light of the above-described problems and has characteristics as follows. Specifically, the present invention is characterized by, in a system for setting a 3D flight plan route of an unmanned aerial vehicle, inputting data indicating a scheduled flight route of the unmanned aerial vehicle on a horizontal plane; acquiring a height reference value indicating an elevation of a surface under each of a plurality of positions on the flight plan route; and determining values obtained by adding flight altitudes corresponding to the positions to the height reference values, respectively, as altitude data on the flight plan route.

The present invention may include a component that reads, from a geographic database, an elevation of a ground surface under each of the plurality of positions on the flight plan route in the horizontal plane as the height reference value. The present invention may include a component that reads, from a database, an altitude of a floor surface inside a building under each of the plurality of positions on the flight plan route in the horizontal plane as the height reference value. The present invention may include a component that identifies, on any entity on the ground surface, a proximate place at which a distance from the flight plan route is equal to or less than a predetermined safe distance. The present invention may include a component that outputs a distance and an orientation from a position on the flight plan route corresponding to the identified proximate place to the identified proximate place. The present invention may include a component that issues a warning when the proximate place is identified.

The present invention may include a component that corrects the flight plan route such that the proximate place is avoided. The present invention may include a component that automatically corrects the flight plan route such that a distance between the flight plan route and the proximate place becomes the safe distance or greater. The present invention may include a component that corrects the flight plan route such that the proximate place is circumvented on the horizontal plane. The present invention may include a component that corrects the flight plan route such that the proximate place is avoided above the proximate place. The present invention may include a component that corrects the flight plan route such that the proximate place is circumvented on the horizontal plane so as to prevent the flight plan route from exceeding a predetermined altitude limit.

The present invention may include a component that reads an altitude above ground level of a structure existing under the flight plan route from a structure shape database, and identifies, on the structure, a place at which an altitude difference obtained by subtracting the altitude above ground level of the structure from an altitude above ground level of a portion of the flight plan route above the structure is equal to or less than the predetermined safe distance as the proximate place. The present invention may include a component that, when reading the altitude above ground level of the structure existing under the flight plan route from the structure shape database, widens the flight plan route based on a predetermined width and reads the altitude above ground level of the structure existing under the flight plan route from the structure shape database.

The present invention may include a component that causes the flight plan route to be three-dimensionally displayed in a screen. The present invention may include a component that causes the proximate place to be further displayed in a superimposed manner. The present invention may include a component that acquires data on a video of an external scene during a flight shot by the unmanned aerial vehicle, acquires data on an actual flight route of the unmanned aerial vehicle, and reproduces the data on the video of the external scene while showing a position where the video is shot by the unmanned aerial vehicle.

The present invention may be a system including the above-described characteristics, may be a method executed by the system, may be a computer program that, when executed by a computer, implements the system, or may be a storage medium (CD-ROM, DVD, or the like) recording or a program product providing such a computer program.

### Advantageous Effects of Invention

The present invention has an advantageous effect that a 3D flight plan route can be determined only by inputting positions of waypoints on a horizontal plane, because data indicating a scheduled flight route of an unmanned aerial vehicle on a horizontal plane is inputted; a height reference value indicating an elevation of a surface under each of a plurality of positions on the flight plan route is acquired; and values obtained by adding flight altitudes corresponding to the positions to the height reference values, respectively, are determined as altitude data on the flight plan route.

The present invention has an advantageous effect that a 3D flight plan route can be determined without needing inputs of elevations of ground surfaces along the flight plan route when the present invention includes the component that reads, from the geographic database, an elevation of a ground surface under each of the plurality of positions on the flight plan route in the horizontal plane as the height reference value. The present invention has an advantageous effect that a flight plan route can be set within a room inside a building when the present invention includes the component that reads, from the database, an altitude of a floor surface inside a building under each of the plurality of positions on the flight plan route in the horizontal plane as the height reference value. The present invention has an advantageous effect that a proximate position that is at risk for collision if a flight is conducted along a flight plan route can be identified when the present invention includes the component that identifies, on any entity on the ground surface, a proximate place at which a distance from the flight plan route is equal to or less than a predetermined safe distance. The present invention has an advantageous effect that a positional relationship between a flight plan route and a proximate place can be appropriately communicated to a user when the present invention includes the component that outputs a distance and an orientation from a position on the flight plan route corresponding to the identified proximate place to the identified proximate place. The present invention has an advantageous effect that existence of a proximate place at risk for collision can be reliably communicated to a user when the present invention includes the component that issues a warning when the proximate place is identified.

The present invention has an advantageous effect that a possibility of collision of an unmanned aerial vehicle against an obstacle such as a structure can be easily and reliably reduced when the present invention includes the component that corrects the flight plan route such that the proximate place is avoided. The present invention has an advantageous effect that a flight plan route can be automatically set such that an unmanned aerial vehicle keeps a distance that is not less than a safe distance from an obstacle such as a structure when the present invention includes the component that automatically corrects the flight plan route such that a distance between the flight plan route and the proximate place becomes the safe distance or greater. The present invention has an advantageous effect that a flight plan route can be corrected without changing a flight altitude when the present invention includes the component that corrects the flight plan route such that the proximate place is circumvented on the horizontal plane. The present invention has an advantageous effect that a flight plan route can be corrected without changing the flight plan route on a horizontal plane when the present invention includes the component that corrects the flight plan route such that the proximate place is avoided above the proximate place. The present invention has an advantageous effect that a flight plan route can be corrected by making as small a change as possible in the flight plan route on a horizontal plane while it is assured that an altitude limit is not exceeded when the present invention includes the component that corrects the flight plan route such that the proximate place is circumvented on the horizontal plane so as to prevent the flight plan route from exceeding a predetermined altitude limit.

The present invention has an advantageous effect that a proximate place can be identified simply by altitude comparison when the present invention includes the component that reads an altitude above ground level of a structure existing under the flight plan route from a structure shape database, and identifies, on the structure, a place at which an altitude difference obtained by subtracting the altitude above ground level of the structure from an altitude above ground level of a portion of the flight plan route above the structure is equal to or less than the predetermined safe distance as the proximate place. The present invention has an advantageous effect that a proximate place on a structure that is not vertically under a flight plan route can be appropriately identified when the present invention includes the component that, when reading the altitude above ground level of the structure existing under the flight plan route from the structure shape database, widens the flight plan route based on a predetermined width and reads the altitude above ground level of the structure existing under the flight plan route from the structure shape database.

The present invention has an advantageous effect that a flight plan route can be displayed in such a manner that can be easily perceived by a user when the present invention includes the component that causes the flight plan route to be three-dimensionally displayed in a screen. The present invention has an advantageous effect that a proximate place can be displayed in such a manner that can be easily perceived by a user when the present invention includes the component that causes the proximate place to be further displayed in a superimposed manner. The present invention has an advantageous effect that a shot video, associated with positions where the video is shot, can be provided to a user in real time during a flight or after completion of the flight when the present invention includes the component that acquires data on a video of an external scene during a flight shot by the unmanned aerial vehicle, acquires data on an actual flight route of the unmanned aerial vehicle, and reproduces the data on the video of the external scene while showing a position where the video is shot by the unmanned aerial vehicle.

### BRIEF DESCRIPTION OF DRAWINGS

FIG. 1 shows a relation of a flight plan route setting system with a database server cooperating with the flight plan route setting system and an unmanned aerial vehicle.

FIG. 2 is an external view of a multicopter that is an example of the unmanned aerial vehicle for which a flight plan route is set.

FIG. 3 is a block diagram showing a functional configuration of the unmanned aerial vehicle.

FIG. 4 is a block diagram showing a functional configuration of the flight plan route setting system that is an embodiment of the present invention.

FIG. 5 is a function block diagram showing a functional configuration of an information processing section included in the flight plan route setting system.

FIG. 6 is a block diagram showing a configuration of the database server.

FIG. 7 is an operation flowchart at time of setting a flight plan route, in the flight plan route setting system.

FIG. 8 is an operation flowchart at time of setting the flight plan route, in the flight plan route setting system.

FIG. 9 is a more specific operation flowchart at time of identifying a proximate place, in the flight plan route setting system.

FIG. 10 is a more specific operation flowchart at time of correcting the flight plan route, in the flight plan route setting system.

FIG. 11 is an operation flowchart at time of three-dimensionally displaying the flight plan route, in the flight plan route setting system.

FIG. 12 is an operation flowchart when the unmanned aerial vehicle flies, in the flight plan route setting system.

FIG. 13 is an operation flowchart at time of confirming an actual flight route of the unmanned aerial vehicle, in the flight plan route setting system.

FIG. 14 is an image view of a main screen of flight planning software PF-Station.

FIG. 15 is an image view of an initial screen of a flight plan route setting screen.

FIG. 16 is an image view of a screen at time of adding a waypoint of the flight plan route setting screen.

FIG. 17 is an image view of a screen in which a flight area and a flight plan route are three-dimensionally displayed.

FIG. 18 is an image view of a screen in which a flight area, structures, and a flight plan route are three-dimensionally displayed.

FIG. 19 is an image view of a screen in which video data is reproduced while a shooting position is shown.

### DESCRIPTION OF EMBODIMENTS

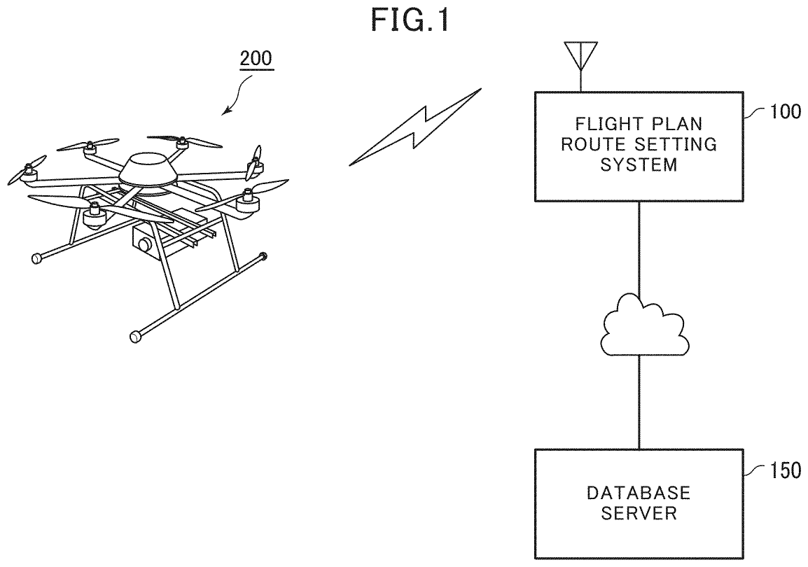

Hereinafter, a flight plan route setting system 100 for setting a 3D flight plan route of an unmanned aerial vehicle, as an embodiment of the present invention, will be described with reference to drawings. However, the present invention is not limited to specific aspects as described below, and can take various aspects within the scope of technical ideas of the present invention. For example, an unmanned aerial vehicle to which the present invention is applied is not limited to a multicopter as shown in FIG. 1, but may be any unmanned aerial vehicle such as a rotorcraft or a fixed-wing aircraft and does not need to be an unmanned aerial vehicle of autonomous-flight type. A system configuration of the flight plan route setting system is not limited to a configuration shown in drawings, but any configuration may be made as long as similar operations are possible. For example, operations performed by a plurality of components may be performed by a single component, such as by integrating functions of a communication circuit into a control section, or operations performed by a single component may be performed by a plurality of components, such as by dividing functions of a main computation section among a plurality of computation sections. The flight plan route setting system may include one or some, or all, of functions of a server cooperating with the flight plan route setting system, or the server may include one or some of functions of the flight plan route setting system. Various databases included in the server may be deployed at a different place from an inside of the server, and the flight plan route setting system 100 may store all or part of information stored in the databases. As for the information stored in the various databases, one type of information may be divided into a plurality of types of information and stored, and a plurality of types of information may be collected into one type and stored.

### Explanation of Terms

“Height” is a vertical length. “Elevation” is a height above mean sea level. “Altitude” means a height of a point of measurement and, in many cases, is indicated by a height above sea level (meters above sea level) unless otherwise specified. “Altitude above ground level” is a height above a ground surface. “Flight altitude” is a height at which a flight takes place and is indicated by an altitude above ground level. “Altitude limit” is a height below which a flight is constrained and is indicated by an altitude above ground level.

Configuration of Entire System

FIG. 1 shows a relation of the flight plan route setting system 100 according to the present invention with a database server 150 cooperating with the flight plan route setting system 100 and an unmanned aerial vehicle 200. The flight plan route setting system 100 and the unmanned aerial vehicle 200 are connected typically through wireless communication, and the flight plan route setting system 100 and the database server 150 are connected via a network. The flight plan route setting system 100 sets a flight plan route for the unmanned aerial vehicle 200 in cooperation with the database server 150.

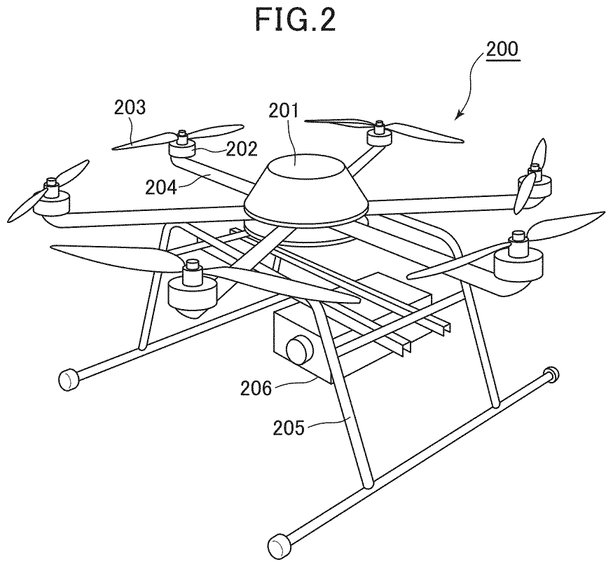

FIG. 2 shows an external view of a multicopter that is an example of the unmanned aerial vehicle for which a flight plan route is set in accordance with the present invention. The unmanned aerial vehicle (multicopter) 200, in terms of external appearance, includes a control unit 201, six motors 202 that are driven by a control signal from the control unit 201, six rotors (rotor blades) 203 that are rotated by the driving of the respective motors 202 and generate lift forces, six arms 204 connecting the control unit 201 and the respective motors 202, and landing gears 205 that support the unmanned aerial vehicle at time of landing. The numbers of the motors 202, the rotors 203, and the arms 204 can be set at any numbers, respectively, that are not smaller than four, such as four or five. The six motors 202 are rotated by the control signal from the control unit 201, and a rotation speed of each of the six rotors 203 is controlled by the rotation of each corresponding motor 202, whereby flight of the unmanned aerial vehicle 200, such as climbing, descending, flying forward, backward, rightward, and leftward, and turning, is controlled. Preferably, a video camera 206 is attached to the unmanned aerial vehicle 200, at an appropriated place such as a lower portion of a main body of the unmanned aerial vehicle 200.

Configuration of Unmanned Aerial Vehicle

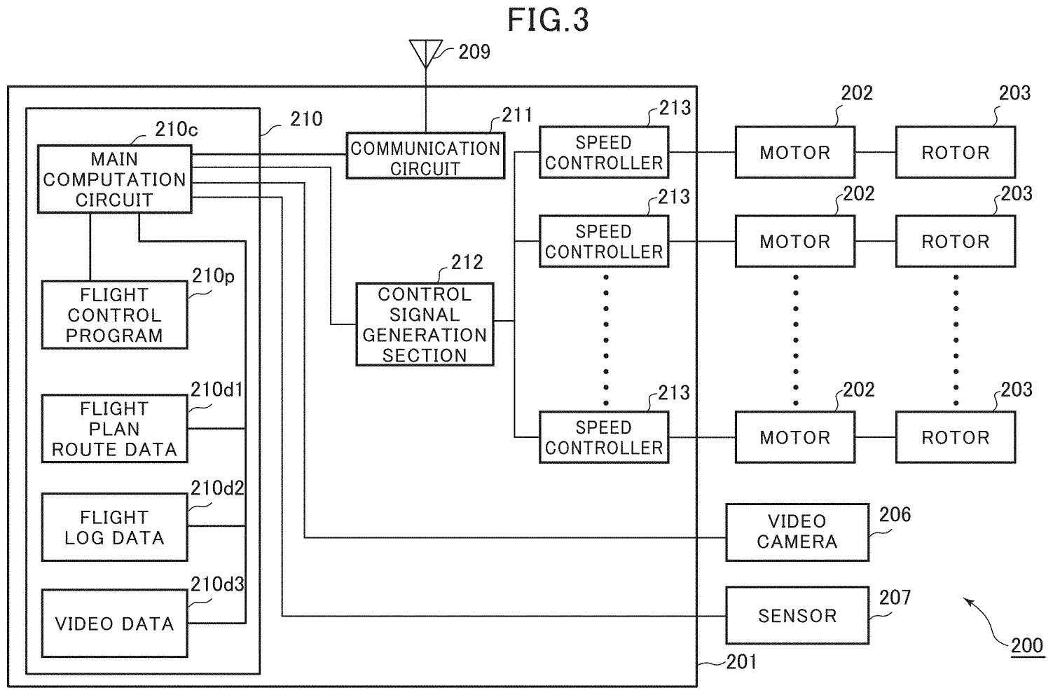

FIG. 3 is a block diagram showing a configuration of the unmanned aerial vehicle 200 used in combination with the flight plan route setting system 100 of the present invention. The unmanned aerial vehicle 200, in terms of function, broadly includes the control unit 201, the motors 202 electrically connected to the control unit 201, the rotors 203 mechanically connected to the motors 202, the video camera 206, a sensor 207, and an antenna 209. The control unit 201 is a component for performing information processing and electric signal control for flight of the unmanned aerial vehicle 200 and, typically, is a unit including a predetermined circuit configured by arranging and wiring various electronic parts on a board. The control unit 201 further includes an information processing unit 210, a communication circuit 211, a control signal generation section 212, and speed controllers 213.

The video camera 206 is a camera for shooting a video attached at an appropriate position such as the lower portion, a side portion, or an upper portion of the unmanned aerial vehicle 200. The sensor 207 includes various sensors for assisting flight of the unmanned aerial vehicle 200, such as a GPS (Global Positioning System) sensor, an attitude sensor, an altitude sensor, an orientation sensor, and a distance sensor (of ultrasonic type, radar type, or the like). The GPS sensor is a sensor for acquiring position information on the unmanned aerial vehicle 200 and is used to control a position of the unmanned aerial vehicle 200 at time of flight. The attitude sensor is a sensor for detecting an inclination and the like of the unmanned aerial vehicle 200 and is used to control an attitude of the unmanned aerial vehicle 200 at time of flight. The altitude sensor is a sensor that detects an altitude of the unmanned aerial vehicle 200 based on atmospheric pressure and the like and is used to control the altitude of the unmanned aerial vehicle 200 at time of flight. The distance sensor is a sensor that measures a distance of the unmanned aerial vehicle 200 to a surrounding object and is used for control to prevent collision with an obstacle.

The information processing unit 210 includes a storage section (not shown) and a main computation circuit 210c that includes a processor, a transitory memory, and the like and performs various computation and flow control, and the storage section stores a flight control program 210p, flight plan route data 210d1, flight log data 210d2, and video data 210d3. It is preferable that the storage section be a nonvolatile memory, more specifically, a flash memory, a backup RAM memory, or the like.

The communication circuit 211 is an electronic circuit for converting a flight control signal for the unmanned aerial vehicle 200, a control signal, various data, or the like outputted from the main computation circuit 210c into a high-frequency signal for wireless communication to have the high-frequency signal carry such a signal or data, and for demodulating a high-frequency signal carrying a telemetry signal or the like transmitted from the unmanned aerial vehicle 200 and extracting the carried signal and, typically, is a radio signal processing IC. Note that, for example, different communication circuits for different frequencies may be configured to perform communication of the flight control signal and communication of the control signal and the various data, respectively. For example, a configuration can be made such that a transmitter of a controller for manual flight control (a proportional system) and the unmanned aerial vehicle 200 communicate the flight control signal by using 950 MHz-band frequency, and the flight plan route setting system 100 and the unmanned aerial vehicle 200 communicate the data by using 2 GHz-band/1.7 GHz-band/1.5 GHz-band/800 MHz-band frequency.

The control signal generation section 212 is a component that converts control instruction value data acquired by the main computation circuit 210c through computation into a pulse signal indicating a voltage (a PWM signal or the like) and, typically, is an IC including an oscillation circuit and a switching circuit. Each of the speed controllers 213 is a component that converts a pulse signal from the control signal generation section 212 into driving voltage for driving a corresponding one of the motors 202 and, typically, includes a smoothing circuit and an analog amplifier. The unmanned aerial vehicle 200 includes a power supply system (not shown) including a battery device such as a lithium polymer battery or a lithium-ion battery and a distribution system to each element.

The flight control program 210p is a program for appropriately controlling flight of the unmanned aerial vehicle 200, based on a flight control signal from an operator (at time of non-autonomous flight), an autonomous flight program following a flight plan route (at time of autonomous flight), or the like. Specifically, the flight control program 210p determines a current position, a speed, and the like of the unmanned aerial vehicle 200 based on information acquired from the various sensors in the sensor 207, causes the main computation circuit 210c to compute a control instruction value for each rotor 203 by comparing the determined values with target values such as the flight plan route, a speed limit, and an altitude limit, and transmits data indicating the control instruction value to the control signal generation section 212. The control signal generation section 212 converts the data indicating the control instruction value into a pulse signal indicating a voltage and transmits the pulse signal to each speed controller 213, and each speed controller 213 converts the pulse signal into driving voltage, applies the driving voltage to each motor 202, and thus controls driving of each motor 202 and hence controls a rotation speed of each rotor 203, whereby flight of the unmanned aerial vehicle 200 is controlled. Flight log information including a flight route along which the unmanned aerial vehicle 200 actually flies (an aircraft position of the unmanned aerial vehicle 200 at each time of day, or the like), various sensor data, and the like is recorded as flight log data 210d2 at any appropriate time during a flight.

The flight plan route data 210d1 is data indicating a flight plan route in three dimensions (latitude, longitude, altitude) of the unmanned aerial vehicle 200 and, typically, is data on a set of a plurality of waypoints in series existing on the flight plan route. The flight plan route, typically, is a straight line sequentially connecting the plurality of waypoints, but can be a curve with a predetermined curvature within a predetermined range of waypoints. The flight plan route data 210d1 may include data that defines a flight speed at the plurality of waypoints. The flight plan route data 210d1 is typically used to define a flight route in an autonomous flight, but can also be used as guidance during flight in a non-autonomous flight. The flight plan route data 210d1 is typically received before a flight by the unmanned aerial vehicle 200 from the flight plan route setting system 100 and stored. The flight log data 210d2 is data indicating telemetry information such as a route along which the unmanned aerial vehicle 200 actually flies and a flight state. The flight log data 210d2 is typically stored in the storage section during a flight of the unmanned aerial vehicle 200. Note that it is preferable that a configuration be made such that the data indicating telemetry information is wirelessly transmitted to the flight plan route setting system 100 in real time during a flight of the unmanned aerial vehicle 200. The video data 210d3 is data showing a video shot by the video camera 206 during a flight of the unmanned aerial vehicle 200 and, typically, is stored in the storage section during the flight of the unmanned aerial vehicle 200. Note that it is also possible that the shot video data is wirelessly transmitted to the flight plan route setting system 100 in real time without being stored as the video data 210d3 in the unmanned aerial vehicle 200.

Configuration of Flight Plan Route Setting System

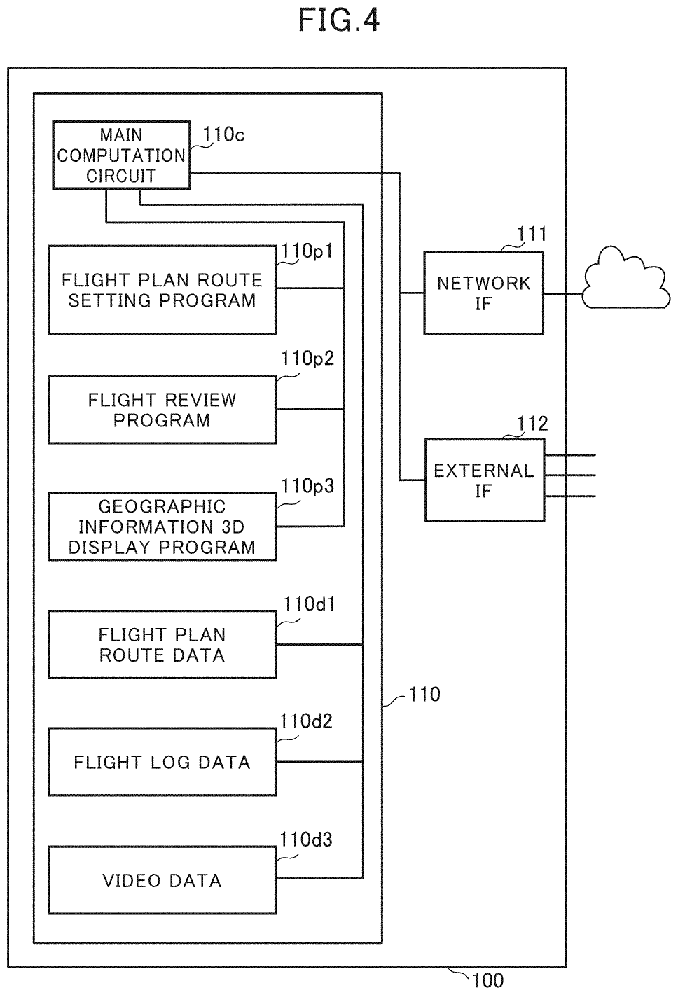

FIG. 4 is a block diagram showing a configuration of the flight plan route setting system 100. The flight plan route setting system 100, typically, is an embodiment implemented by installing software for setting a flight plan route and software for three-dimensionally displaying geographic information in a computer platform such as a notebook PC. The flight plan route setting system 100, in terms of function, broadly includes an information processing section 110, a network interface (IF) 111, and an external interface (IF) 112. The information processing section 110 includes a storage section (not shown) and a main computation circuit 110c that includes a processor, a transitory memory, and the like and performs various computation and flow control, and in the storage section, an area is secured in which a flight plan route setting program 110p1, a flight review program 110p2, a geographic information 3D display program 110p3, flight plan route data 110d1, flight log data 110d2, and video data 110d3 are stored. It is preferable that the storage section be a high-speed large-capacity storage device, more specifically, a hard disk or the like. The network IF 111 is an IF for connecting to a server and the like on the network via the network. The external interface IF 112 is for connecting to external equipment. The external interface IF 112 has a plurality of connection ports and, typically, connects to a communication unit (not shown) that performs wireless communication of data with the unmanned aerial vehicle 200, and user interface equipment such as a display unit, a keyboard, a mouse and the like.

The flight plan route setting program 110p1 is executed by the main computation circuit 110c and thereby provides a function of setting a flight plan route of the unmanned aerial vehicle 200 based on inputs from a user and storing the flight plan route as the flight plan route data 110d1. The flight review program 110p2 is executed by the main computation circuit 110c and thereby causes a flight route of an actual flight of the unmanned aerial vehicle 200 and a video recorded during the flight by the unmanned aerial vehicle 200 to be displayed based on the flight log data 110d2 and the video data 110d3. The flight plan route data 110d1 is data indicating a flight plan route to be stored as the flight plan route data 210d2 in the unmanned aerial vehicle 200 and is created by the flight plan route setting system 100. The flight log data 110d2 is the transferred flight log data 210d2 in the unmanned aerial vehicle 200. The video data 110d3 is the transferred video data 210d3 in the unmanned aerial vehicle 200.

The geographic information 3D display program 110p3 is executed by the main computation circuit 110c and thereby reads, via the database server 150, geographic data showing terrain and the like from a geographic database 161 and shape data on structures and the like on the ground that can be obstacles to a flight of the unmanned aerial vehicle 200 from a structure shape database 162, draws a flight plan route defined by the flight plan route data 110d1 in a superimposing manner on an image in which the structures are deployed on the ground, and causes a display unit to display the resultant image. For the geographic information 3D display program 110p3, a program implementing a GIS (Geographic Information System) such as Google Earth®, or the like can be used.

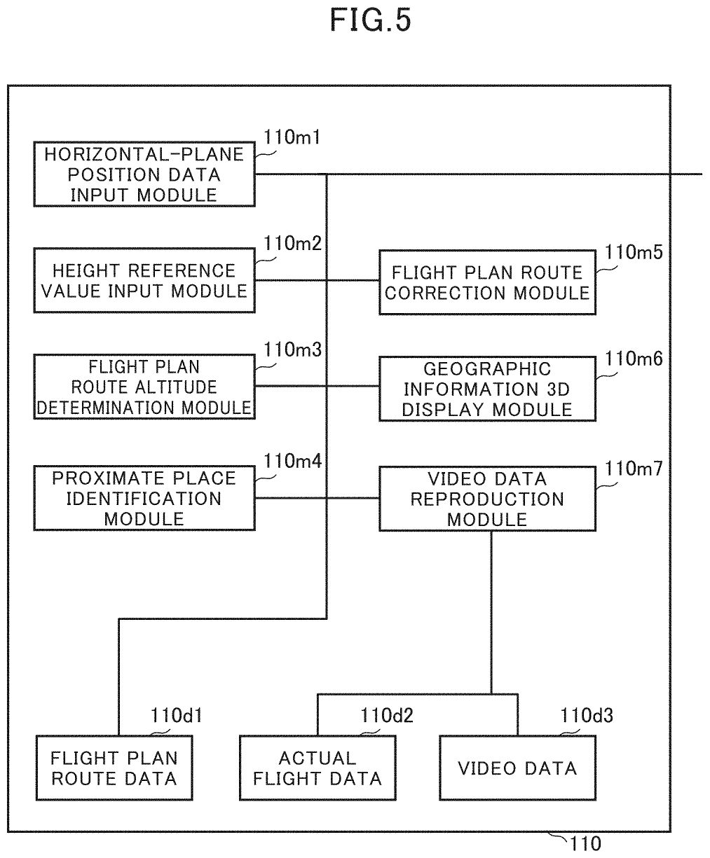

FIG. 5 is a function block diagram showing a functional configuration of the information processing section 110 included in the flight plan route setting system 100. FIG. 5 shows a configuration of function modules implemented by software in a control section of the flight plan route setting system 100. The information processing section 110, in terms of function, includes a horizontal-plane position data input module 110m1, a height reference value input module 110m2, a flight plan route altitude determination module 110m3, a proximate place identification module 110m4, a flight plan route correction module 110m5, a geographic information 3D display module 110m6, a video data reproduction module 110m7, the flight plan route data 110d1, the flight log data 110d2, and the video data 110d3. The horizontal-plane position data input module 110m1, the height reference value input module 110m2, the flight plan route altitude determination module 110m3, the proximate place identification module 110m4, and the flight plan route correction module 110m5 are modules caused to function in such a manner that the flight plan route setting program 110p1 is executed by the main computation circuit 110c while the flight plan route data 110d1 is referred to when required. The geographic information 3D display module 110m6 is a module caused to function in such a manner that the geographic information 3D display program 110p3 is executed by the main computation circuit 110c while the flight plan route data 110d1 is referred to and the geographic database 161 and the structure shape database 162 are referred to via the database server 150 when required. The video data reproduction module 110m7 is a module caused to function in such a manner that the flight review program 110p2 is executed by the main computation circuit 110c while the flight log data 110d2 and the video data 110d3 are referred to when required. Respective functions of the modules will be described in a description of operation.

Configuration of Database Server

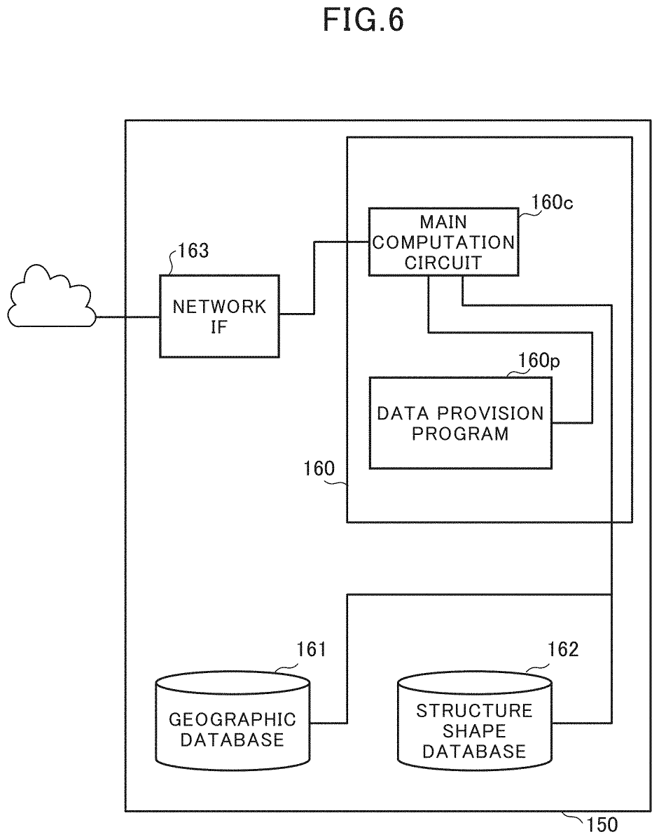

FIG. 6 is a block diagram showing a configuration of the database server 150. The database server 150, in terms of function, broadly includes an information processing section 160, the geographic database 161, the structure shape database 162, and a network interface (IF) 163. The information processing section 160 includes a storage section (not shown) and a main computation circuit 160c that includes a processor, a transitory memory, and the like and performs various computation and flow control, and the storage section stores a data provision program 160p. For the storage section, specifically, a hard disk can be used. The geographic database 161 is a database that manages geographic data showing a photomap, terrain, and the like, and the structure shape database 162 is a database that manages shape data on structures and the like on the ground. The shape data is not limited to data that defines an outer shape of a structure, but may be data that defines a spatial shape of a room inside a structure. What is shown by the shape data is not limited to shapes of structures, but may be shapes of various entities on the ground.

The data provision program 160p is executed by the main computation circuit 160c and thereby reads, in response to a request for data from the flight plan route setting system 100 via the network, the geographic data showing terrain and the like from the geographic database 161 and the shape data on a structure or the like on the ground that can be an obstacle to a flight of the unmanned aerial vehicle 200 from the structure shape database 162, and provides the data to the flight plan route setting system 100 via the network.

Operation of Flight Plan Route Setting System—Setting of Flight Plan Route

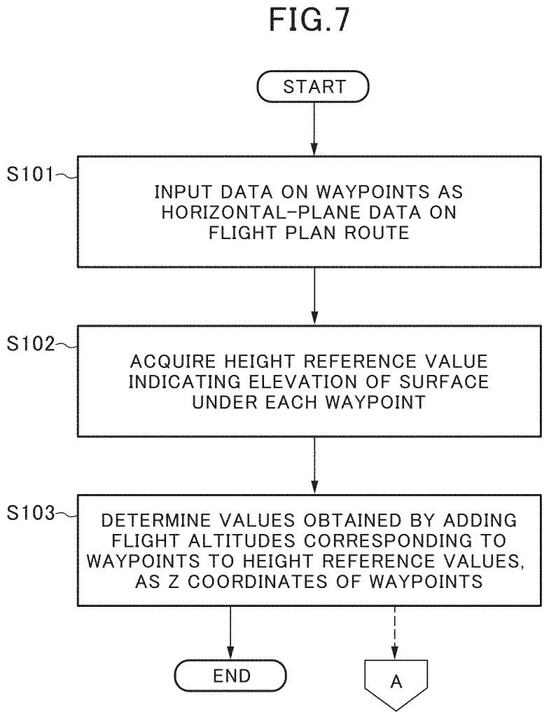

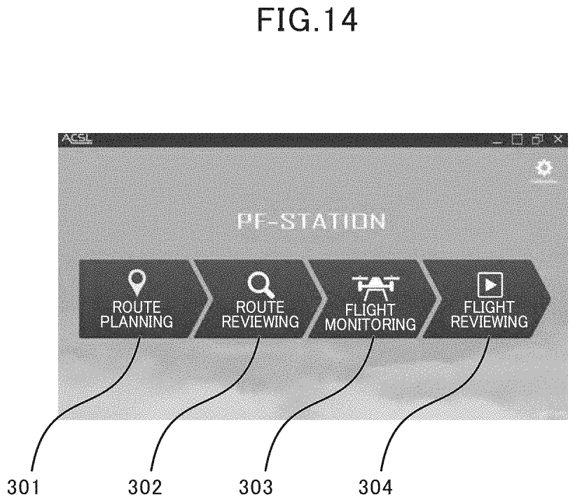

Hereinafter, operation of the flight plan route setting system 100 will be described with reference to drawings. FIG. 7 is an operation flowchart at time of setting a flight plan route, in the flight plan route setting system 100. As a specific example of the flight plan route setting system 100, a PC terminal is used in which PF-Station® that is flight planning software and Google Earth® that is a geographic information system are installed. FIG. 14 is an image view of a main screen of the flight planning software PF-Station. PF-Station has functions that are broadly classified into four categories, “route planning”, “route reviewing”, “flight monitoring”, and “flight reviewing”, and screens providing the functions can be accessed by selecting a route planning button 301, a route reviewing button 302, a flight monitoring button 303, and a flight reviewing button 304 shown in FIG. 14, respectively.

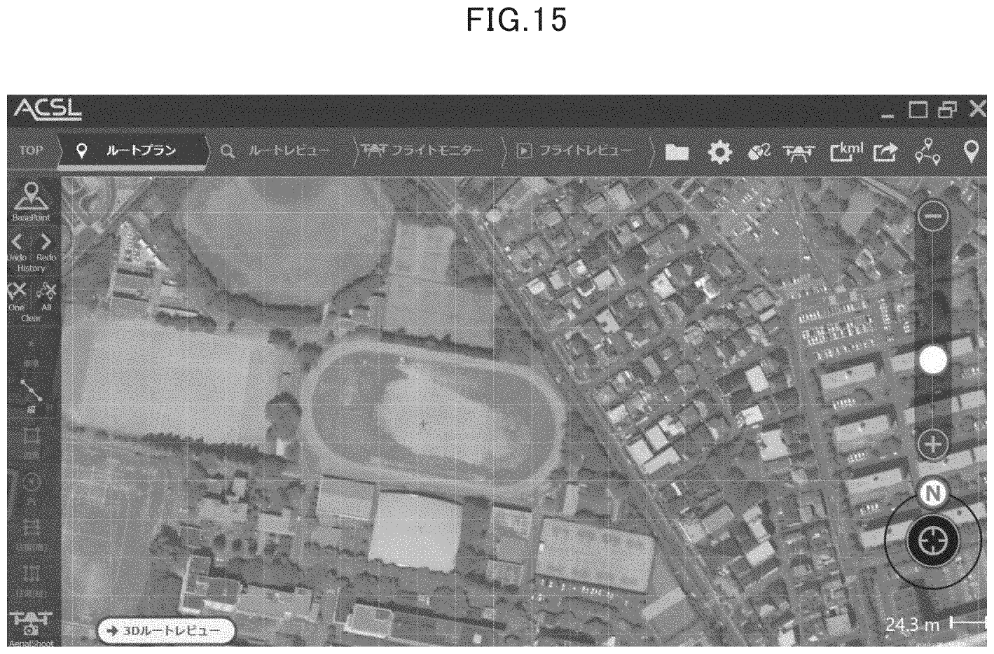

To set a flight plan route, the route planning button 301 is selected, so that a flight plan route setting screen (a route planning screen) is displayed. FIG. 15 is an image view of an initial screen of the flight plan route setting screen of the flight planning software PF-Station. In the flight plan route setting screen, a photomap in a predetermined range is displayed, and buttons for various operations are also displayed. X, Y coordinates (a latitude and a longitude, displacements from a reference position, or the like) are associated with each point on the photomap, and X, Y coordinates associated with a point can be selected by selecting the point on the photomap.

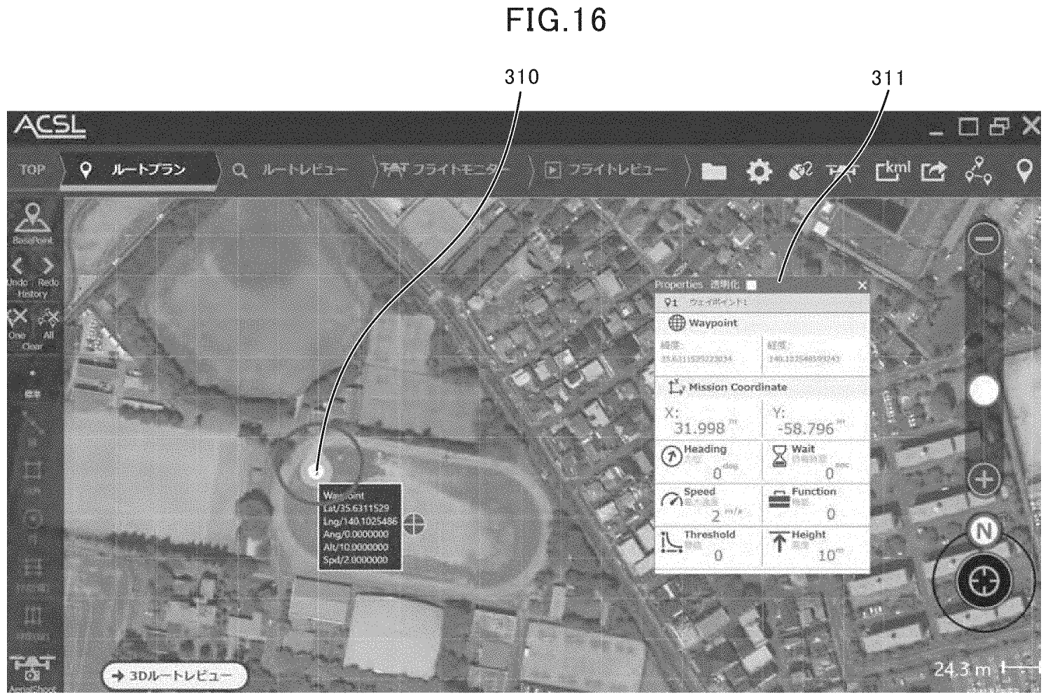

To set the flight plan route, a plurality of waypoints are inputted. FIG. 16 is an image view of a screen at time of adding a waypoint of the flight plan route setting screen. When a user selects, for example by double-clicking or the like, a position at which the user intends to create a waypoint on the photomap, the horizontal-plane position data input module 110m1 identifies X, Y coordinates of a place corresponding to the position and sets the position as X, Y coordinates of the waypoint. In such a manner, the horizontal-plane position data input module 110m1 inputs data on waypoints representing a scheduled flight route of the unmanned aerial vehicle on a horizontal plane into the flight plan route setting system 100 as horizontal-plane data on a flight plan route (step S101). In other words, the horizontal-plane position data input module 110m1 inputs data indicating a scheduled flight route of the unmanned aerial vehicle on a horizontal plane as horizontal-plane data on a flight plan route. In the example shown in FIG. 16, a waypoint 310 is set at a place surrounded by a circle shown slightly to the left of a center of the screen. Detailed information on the waypoint 310 is displayed in a property screen 311 on a right side of the center of the screen, and X, Y coordinates of the waypoint (Mission Coordinates) are shown as 31.998, −58.796, respectively, as displacements from the reference position.

Note that at each waypoint, a flight speed may be defined. For the flight speed, a predetermined flight speed may be preset, or an input of a flight speed may be received from the user. In the example shown in FIG. 16, 2 m/s is displayed as a flight speed (Speed) in the property screen on the right side of the center of the screen.

Next, the height reference value input module 110m2 inquires of the database server 150 about a height reference value indicating an elevation of a surface under a waypoint of interest and acquires the height reference value (step S102). In other words, the height reference value input module 110m2 acquires a height reference value indicating an elevation of a surface under each of the plurality of positions on the flight plan route. Note that height reference values indicating elevations of surfaces may be stored in the flight plan route setting system 100. A surface under a waypoint is a barrier such as a ground surface or a floor surface below which the unmanned aerial vehicle 200 cannot go down. When the database server 150 receives such an inquiry, the data provision program 160p is executed by the main computation circuit 160c, and an elevation of a ground surface under the waypoint of interest is acquired from the geographic database 161, and then transmitted to and acquired by the height reference value input module 110m2 as a height reference value. In other words, the height reference value input module 110m2 reads from the geographic database 161 and acquires an elevation of a ground surface under each of the plurality of positions on the flight plan route on the horizontal plane as a height reference value. At the time, it is also possible that the height reference value input module 110m2 determines whether or not any structure exists under the waypoint of interest, based on the data on positions and heights of structures from the structure shape database 162, and, when a structure exists, calculates an elevation of the structure by adding a height (a height above the ground surface) of a portion of the structure under the waypoint of interest to the elevation of the ground surface and uses the elevation of the structure for a height reference value. When only the ground surface is used as a reference for a flight altitude of the unmanned aerial vehicle 200, it is not necessary to add the height of the structure to the elevation of the ground surface. In such a case, although there is a possibility that the unmanned aerial vehicle 200 interferes with the structure, it is easy to perform control such that the unmanned aerial vehicle 200 does not exceed the altitude limit. When both the ground surface and the structure are used for a reference for a flight altitude of the unmanned aerial vehicle 200, the height of the structure is added to the elevation of the ground surface. In such a case, although there is a possibility that the unmanned aerial vehicle 200 exceeds the altitude limit, it is easy to perform control such that the unmanned aerial vehicle 200 does not interfere with the structure. Moreover, a space such as a room inside a building can also be specified as a space in which the unmanned aerial vehicle 200 flies, and in such a case, if the structure shape database 162 includes data on a height of a floor surface of the space, an elevation of the floor surface is calculated by adding the height of a portion of the floor surface under the waypoint of interest to the elevation of the ground surface, and the elevation of the floor surface is used for a height reference value. In other words, the height reference value input module 110m2 reads from the structure shape database 162 and acquires an altitude of a floor surface inside a building under each of the plurality of positions on the flight plan route on the horizontal plane as a height reference value. As described above, a height reference value is an elevation of a ground surface when no structure exists under the waypoint of interest, is either the elevation of the ground surface or an elevation of a structure calculated by adding a height of the structure to the elevation of the ground surface when the structure exists under the waypoint of interest, and is an elevation of a floor surface calculated by adding a height of the floor surface above a ground surface to the elevation of the ground surface when the waypoint of interest is set in a room inside a building.

Next, the flight plan route altitude determination module 110m3 determines a value calculated by adding a flight altitude corresponding to the waypoint of interest to the height reference value as a Z coordinate of the waypoint (step S103). In other words, the flight plan route altitude determination module 110m3 determines values calculated by adding respective flight altitudes corresponding to the plurality of positions on the flight plan route to the respective height reference values as altitude data on the flight plan route. Thus, the Z coordinates, in addition to the X, Y coordinates, are determined for the flight plan route, and the flight plan route is complete as 3D data. The data on the complete flight plan route is stored as the flight plan route data 110d1. In the example shown in FIG. 16, the flight altitude (Height) that is a height of the waypoint above a ground surface is 10 m. Flight altitudes may be constant, for example, 10 m for all inputted waypoints, or may have different values at different waypoints based on a predetermined rule. For the predetermined rule, a rule that elevations of waypoints should be constant, a rule that flight altitudes should be constant but be decreased so as not to exceed a predetermined elevation, or the like can be used.

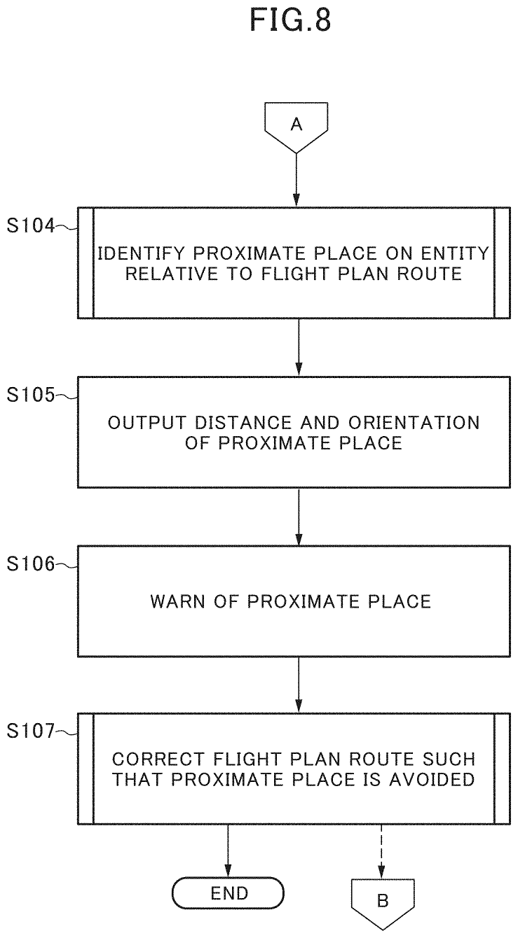

The 3D flight plan route is set through the hitherto steps. However, when only the ground surface is used as a reference for a flight altitude in particular, it is preferable that additional steps as described below be performed so that the flight plan route does not interfere with an obstacle. FIG. 8 is an operation flowchart at time of correcting the flight plan route, in the flight plan route setting system. The proximate place identification module 110m4 identifies a proximate place at which a distance from the flight plan route is equal to or less than a predetermined safe distance, on any entity on the ground surface (step S104). Typically, an entity is a structure. Various methods can be used to perform calculation for identifying the proximate place. For example, a distance between each segment (between each two waypoints) included in the flight plan route and each segment included in a structural model of the entity is obtained. Then, the proximate place identification module 110m4 identifies, as a proximate place, a place on the entity at which the distance is equal to or less than the safe distance. The proximate place may be identified in a unit of a segment representing an outer shape of the entity, or may be identified in a unit of an entity such as a structure. Preferably, a portion of the flight plan route corresponding to the proximate place is also identified. The safe distance is a distance of separation for reducing a possibility that the unmanned aerial vehicle 200 comes in contact with another object, and is set at, for example, 10 m or the like. The safe distance may be varied according to a flight speed of the unmanned aerial vehicle 200. For example, a greater safe distance can be set in a section of a higher flight speed, and a smaller safe distance can be set in a section of a lower flight speed. Different safe distances can also be set in an up-down direction and in a horizontal direction, respectively.

Preferably, the proximate place identification module 110m4 further outputs a relative position, including a distance, an orientation, and the like, from the position on the flight plan route corresponding to the identified proximate place to the identified proximate place (step S105). Outputted position data such as the distance and the orientation is stored in association with the flight plan route and the proximate place. A configuration can be made such that the distance and the orientation are displayed when the flight plan route is set and when a flight log is reviewed. Preferably, the proximate place identification module 110m4 issues a warning when the proximate place identification module 110m4 identifies the proximate place (step S106). The issuance of the warning can be configured to be performed by using various methods. For example, a range in the flight plan route corresponding to the proximate place can be displayed in red. The proximate place can be three-dimensionally displayed on the flight plan route in a superimposed manner and in a form distinguishable from others (for example, in red).

When the proximate place identification module 110m4 identifies the proximate place, the flight plan route correction module 110m5 corrects the flight plan route such that the proximate place is avoided (step S107). The correction can be performed by using various methods. For example, the flight plan route correction module 110m5 can be configured to automatically correct the flight plan route when the proximate place identification module 110m4 identifies the proximate place, such as by moving a waypoint closest to the proximate place farther away from the proximate place on a horizontal plane, a vertical plane, or an inclined plane so that the distance between the flight route plan and the proximate place becomes the safe distance or greater.

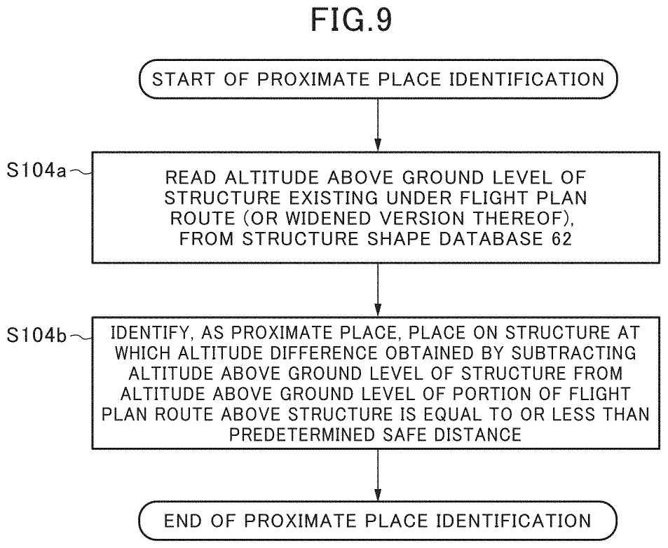

The step of identifying the proximate place (step S104) can be performed, specifically, through steps as described below. FIG. 9 is a more specific operation flowchart at time of identifying a proximate place, in the flight plan route setting system 100. The proximate place identification module 110m4 reads, from the structure shape database 162, an altitude above ground level of an uppermost portion of a structure that is an entity existing under the flight plan route (step S104a). The proximate place identification module 110m4 identifies, as a proximate place, a place on the structure at which an altitude difference calculated by subtracting the altitude above ground level of the structure from an altitude above ground level of a portion of the flight plan route above the structure is equal to or less than the predetermined safe distance (step S104b). Thus, the proximate place can be identified simply by altitude comparison.

In the step of reading the altitude above ground level of the structure under the flight plan route from the structure shape database 162 (step S104a), the proximate place identification module 110m4 can be configured to widen the flight plan route based on a predetermined width and then read the altitude above ground level of the structure under the flight plan route from the structure shape database 162. Thus, a proximate place on a structure that does not exist vertically under the flight plan route can be appropriately identified.

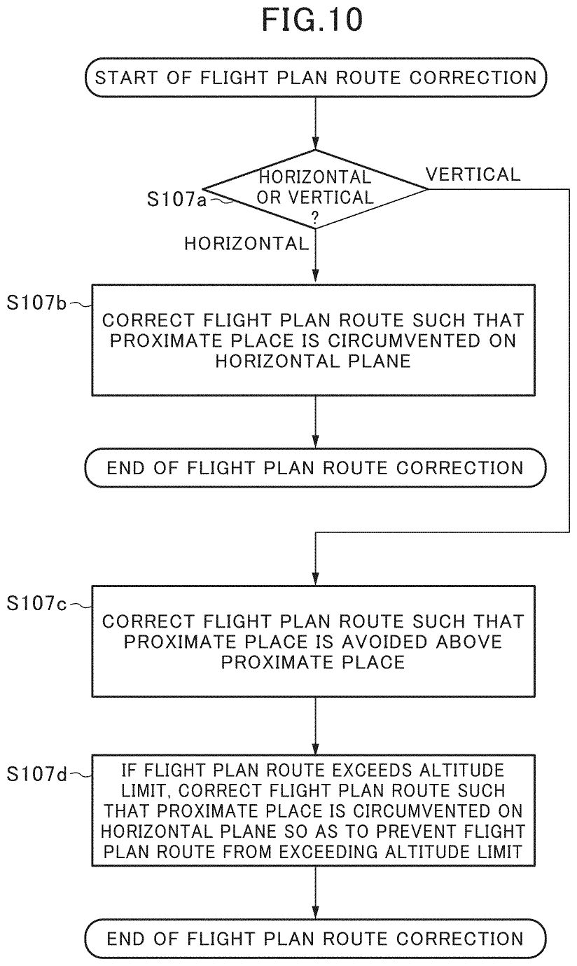

The step of correcting the flight plan route such that the proximate place is avoided (step S107) can be performed, more specifically, through steps as described below. FIG. 10 is a more specific operation flowchart at time of correcting the flight plan route, in the flight plan route setting system 100. The user can allow a direction of avoidance to be determined when the flight plan route is automatically corrected, by setting which of a horizontal direction and a vertical direction is taken to avoid the proximate place (step S107a). When the direction of avoidance is set to a horizontal plane, the flight plan route correction module 110m5 corrects the flight plan route such that the flight plan route circumvents the proximate place on the horizontal plane (step S107b). The correction can be performed, for example, by moving a waypoint closest to the proximate place in an opposite direction to the proximate place on the horizontal plane so that the distance between the flight plan route and the proximate place becomes the safe distance or greater, or the like. When the direction of avoidance is set to a vertical plane, the flight plan route correction module 110m5 corrects the flight plan route such that the flight plan route avoids the proximate place on the vertical plane (step S107c). The correction can be performed, for example, by moving a waypoint closest to the proximate place to an upper side of the proximate place so that the distance between the flight plan route and the proximate place becomes the safe distance or greater, or the like. At the time, preferably, the flight plan route correction module 110m5 checks that the corrected flight plan route does not exceed the altitude limit and, if the flight plan route exceeds the predetermined altitude limit (an altitude above ground level that is a limit) when an attempt is made to avoid the proximate place above the proximate place, corrects the flight plan route such that the proximate place is circumvented on the horizontal plane so as to prevent the flight plan route from exceeding the predetermined altitude limit (step S107d). In such a case, when a height of the flight plan route to be corrected reaches the altitude limit, the safe distance may be secured by correcting the flight plan route in the horizontal direction while the height is kept at the altitude limit.

As described above, a 3D flight plan route can be set by inputting a scheduled flight route of an unmanned aerial vehicle on a horizontal plane, and the flight plan route can be automatically corrected such that an entity such as a structure that is an obstacle is circumvented.

Operation of Flight Plan Route Setting System—Confirmation of Flight Plan Route

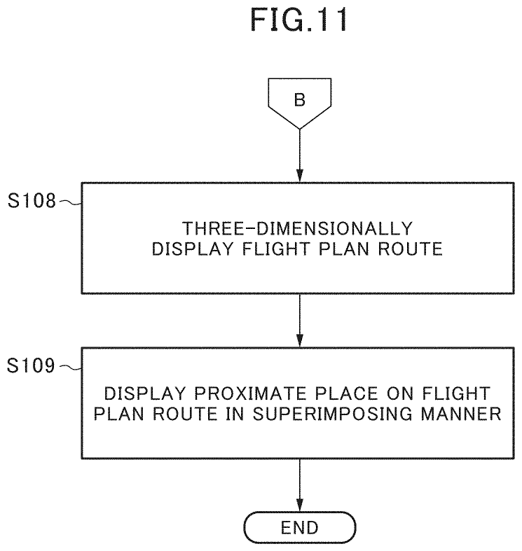

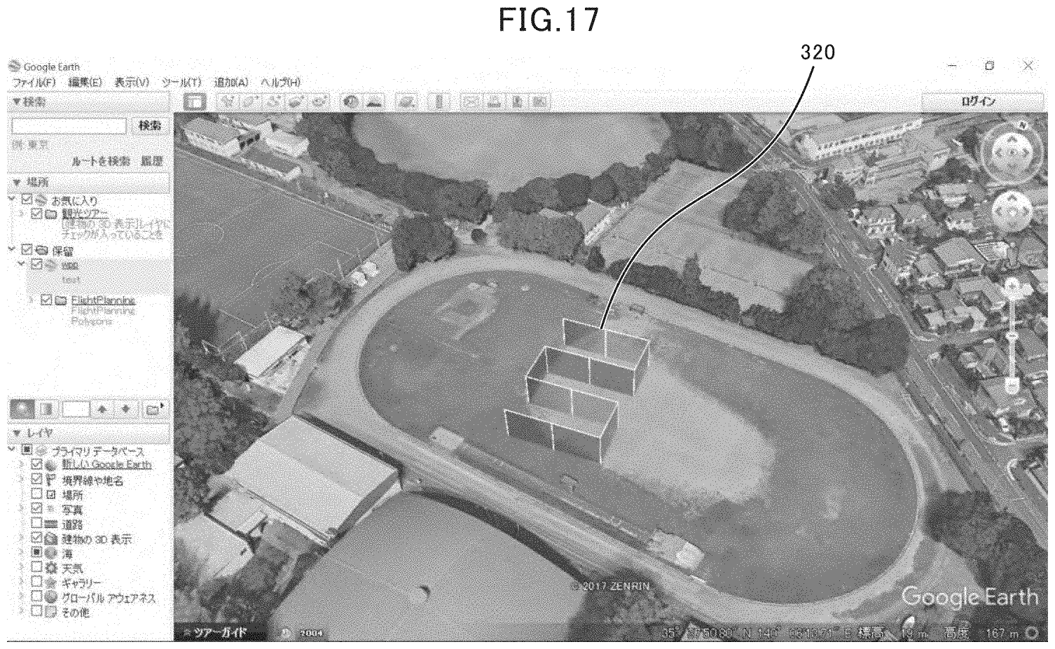

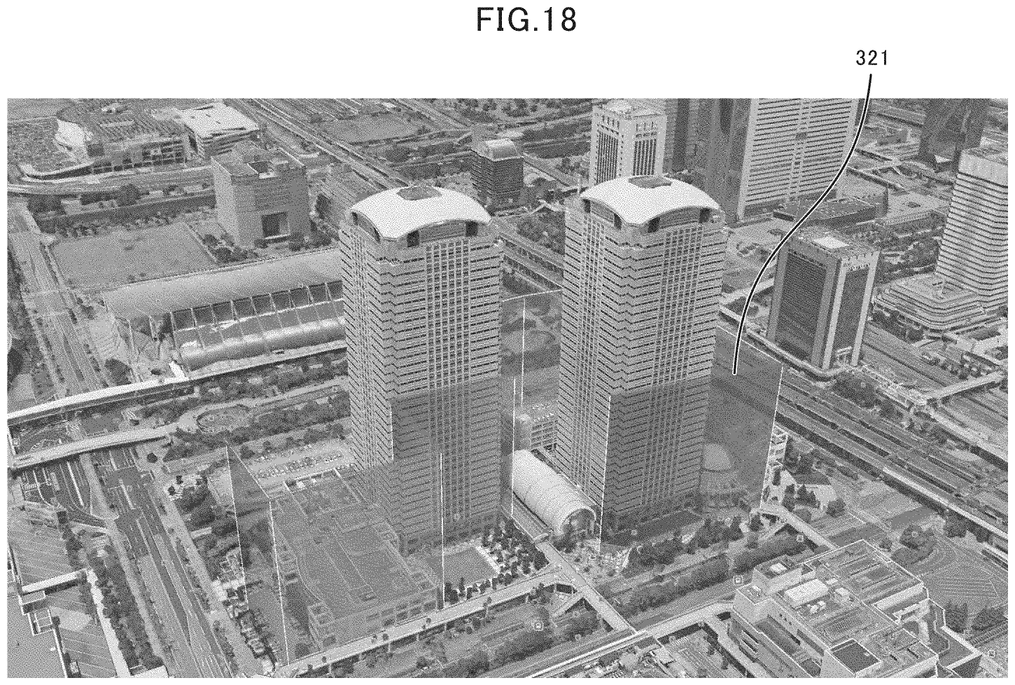

FIG. 11 is an operation flowchart at time of three-dimensionally displaying the flight plan route, in the flight plan route setting system 100. The set flight plan route, which is to be transferred to the unmanned aerial vehicle 200, can be confirmed before the transfer. The geographic information 3D display module 110m6 causes the flight plan route to be three-dimensionally displayed in a screen (step S108). Typically, the geographic information 3D display module 110m6 causes the geographic information 3D display program capable of displaying a terrain based on geographic data to renter a 3D display, by reading the set flight plan route data 110d1 and passing 3D data of the flight plan route data 110d1 to the geographic information 3D display program. A screen for confirming the flight plan route (not shown) can be displayed by selecting the route reviewing button 302 in the main screen of the flight planning software PF-Station shown in FIG. 14. In the confirmation screen, the flight plan route is three-dimensionally displayed with a flight area, for the flight plan route to be confirmed. FIG. 17 is an image view of a screen in which a flight area and a flight plan route are three-dimensionally displayed. In FIG. 17, a flight plan route 320 is three-dimensionally displayed with a flight area. When an instruction to review the flight plan route is received from the user, the geographic information 3D display module 110m6 reads the set flight plan route data 110d1, converts data on the set of waypoints that defines the flight plan route included in the flight plan route data 110d1 into data in a data format that can be read by the geographic information 3D display program, and transmits a request for geographic information 3D display accompanied by the converted data to the geographic information 3D display program executed on the same platform. The geographic information 3D display program interprets coordinates of the flight plan route and requests terrain data on the flight area including the coordinates from the database server 150. The database server 150 acquires the requested terrain data from the geographic database 161 and transmits the terrain data to the geographic information 3D display module 110m6. Here, preferably, the database server 150 also acquires shape data on a structure existing in the flight area from the structure shape database 162 and transmits the shape data to the geographic information 3D display module 110m6. Based on the terrain data on the flight area, the shape data on the structure existing in the flight area, and the flight plan route data 110d1, the geographic information 3D display module 110m6 three-dimensionally draws the flight area, the structure, and the flight plan route, which are then displayed on the display unit. Preferably, the 3D display is rendered by a perspective drawing method. Moreover, it is preferable that the flight plan route be displayed in a folding-screen shape in such a manner that a set of vertical planes above the ground surface with the flight plan route as upper sides of the planes is displayed by using the perspective drawing method. By rendering the display in such a manner, it is perceived at a glance what positional relationships the flight plan route has with the flight area and the structure. FIG. 18 is an image view of a screen in which a flight area, structures, and a flight plan route are three-dimensionally displayed. In FIG. 18, a flight plan route 321 is three-dimensionally displayed with a flight area and structures.

Although the geographic information 3D display module 110m6 renders a 3D display by using the independent geographic information 3D display program as described above, part or the whole of the geographic information 3D display program may be included in the flight planning software.

In the 3D display of the flight plan route, it is possible that the proximate place is concurrently displayed. The geographic information 3D display module 110m6 displays the proximate place on the flight plan route in a superimposing manner (step S109). When the position data such as the distance and the orientation of the proximate place from a certain position on the flight plan route is stored in step S105, the geographic information 3D display module 110m6 reads the position data, transmits the position data on the proximate place to the geographic information 3D display program, and causes the geographic information 3D display program to display the proximate place on the structure in a form distinguishable from others (for example, in red). Preferably, the flight plan route corresponding to the proximate place is also displayed in a form distinguishable from others (for example, in red).

Operation of Flight Plan Route Setting System—Flight of Unmanned Aerial Vehicle 200

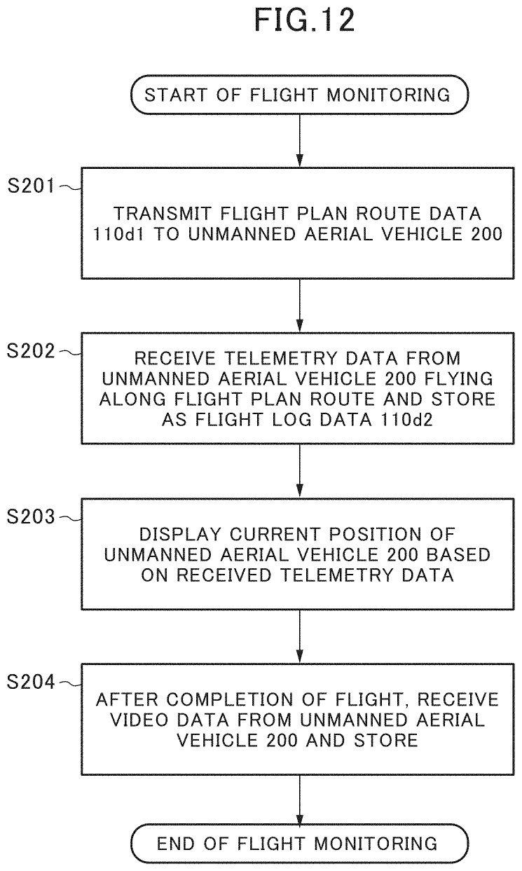

FIG. 12 is an operation flowchart when the unmanned aerial vehicle flies, in the flight plan route setting system. An appropriate flight plan route can be created by confirming the flight plan route after the flight plan route is set as described above. The created flight plan route is transferred to the unmanned aerial vehicle 200 and stored as the flight plan route data 210d1, and the unmanned aerial vehicle 200 can be caused to fly in accordance with the flight plan route data 210d1. The transfer of the flight plan route to the unmanned aerial vehicle 200 and display of a screen for monitoring the unmanned aerial vehicle 200 during a flight (not shown) can be performed by selecting the flight monitoring button 303 in the main screen of the flight planning software PF-Station shown in FIG. 14. The flight plan route setting system 100 reads the flight plan route data 110d1 and transmits the flight plan route data 110d1 to the unmanned aerial vehicle 200 via the communication unit connected to the external interface IF 112 (step S201). The unmanned aerial vehicle 200 receives the transmitted flight plan route data 110d1 via the antenna 209 and the communication circuit 211 and stores the flight plan route data 110d1 as the flight plan route data 210d1. In the unmanned aerial vehicle 200, the flight control program 210p is executed by the main computation circuit 210c, whereby an autonomous flight control function is executed. The autonomous flight control function reads the flight plan route data 210d1 and controls the unmanned aerial vehicle 200 such that the unmanned aerial vehicle 200 flies along the flight plan route defined by the flight plan route data 210d1. Preferably, the flight plan route data 210d1 includes data on a flight speed, and the unmanned aerial vehicle 200 is controlled such as to fly along the flight plan route at the flight speed. A non-autonomous flight may be conducted in such a manner that the autonomous flight control function receives a manual operation from the user during the flight. In such a case, the flight plan route is used for guidance.

The unmanned aerial vehicle 200 shoots a video of surroundings by using the video camera 206 during the flight and stores the video as the video data 210d3. The unmanned aerial vehicle 200 acquires positions and speeds during the flight by using the sensor 207 such as a GPS receiver and stores such telemetry data as the flight log data 210d2. The video data is associated with data on shooting positions, so that it can be identified at which position the video is shot. It is preferable that the unmanned aerial vehicle 200 transmit the telemetry data such as the positions and the speeds during the flight to the flight plan route setting system 100 in real time. The unmanned aerial vehicle 200 can also be configured such that when the unmanned aerial vehicle 200 deviates from the flight plan route and approaches an obstacle such as a structure to come within a predetermined distance from the obstacle during the flight, the sensor 207 detects such an approaching state, which is then transmitted to the flight plan route setting system 100 by being included in the telemetry data, or stored by being included in the flight log data 210d2. For the sensor 207 used at the time, the distance sensor (of ultrasonic type, radar type, or the like) is preferably used. For example, the unmanned aerial vehicle 200 can also be configured such as to, when a flight position at which a distance to a structure is equal to or less than a predetermined distance occurs in an actual flight route, add the distance and warning information into the telemetry data and add the then flight position into the flight log data 210d2 for storage, regardless of whether or not deviation from the flight plan route occurs.

The flight plan route setting system 100 receives the telemetry data from the unmanned aerial vehicle 200 during the flight and stores the telemetry data as the flight log data 110d2 (step S202). The flight plan route setting system 100 then displays a current position of the unmanned aerial vehicle 200 and numerical values of the telemetry data, based on the received telemetry data (step S203). It is preferable that the current position of the unmanned aerial vehicle 200 be displayed in such a manner that the actual flight route is displayed on the photomap, and the current position is displayed on the actual flight route in a superimposed manner. At the time, the flight plan route may be three-dimensionally displayed. When the received telemetry data includes information to the effect that the unmanned aerial vehicle 200 approaches an obstacle such as a structure to come within the predetermined distance from the obstacle, it is preferable that the flight plan route setting system 100 display the information as a warning.

The unmanned aerial vehicle 200 may transmit video data shot by the video camera 206 to the flight plan route setting system 100 in real time. The flight plan route setting system 100 may be configured to display the received video data along with a corresponding shooting position in real time. Thus, when some target is monitored by using the video camera 206, a state of the target can be learnt in real time. When a non-autonomous flight is conducted, the video data can also be used as guidance for the flight. The unmanned aerial vehicle 200 may autonomously fly in an area where radio waves from the flight plan route setting system 100 and an operation terminal do not reach. The telemetry data during the autonomous flight may be transmitted to the flight plan route setting system 100 when the unmanned aerial vehicle 200 comes back to a reachable range of radio waves.

After completion of the flight, the unmanned aerial vehicle 200 transmits the video data 210d3 to the flight plan route setting system 100, and the flight plan route setting system 100 receives the video data 210d3 and stores the video data 210d3 as the video data 110d3 (step S204). The video data 210d3 may be passed from the unmanned aerial vehicle 200 to the flight plan route setting system 100 by using a medium such as an SD Card®. When the telemetry data is not transmitted in real time, the unmanned aerial vehicle 200 transmits the flight log data 210d2 to the flight plan route setting system 100 after completion of the flight to allow the flight log data 210d2 to be stored as the flight log data 110d2.

Operation of Flight Plan Route Setting System—Confirmation of Flight Log

After completion of the flight of the unmanned aerial vehicle 200, the flight plan route setting system 100 can perform an operation for confirming a state of the flight. A screen for confirming a flight state (not shown) can be displayed by selecting the flight reviewing button 304 in the main screen of the flight planning software PF-Station shown in FIG. 14.

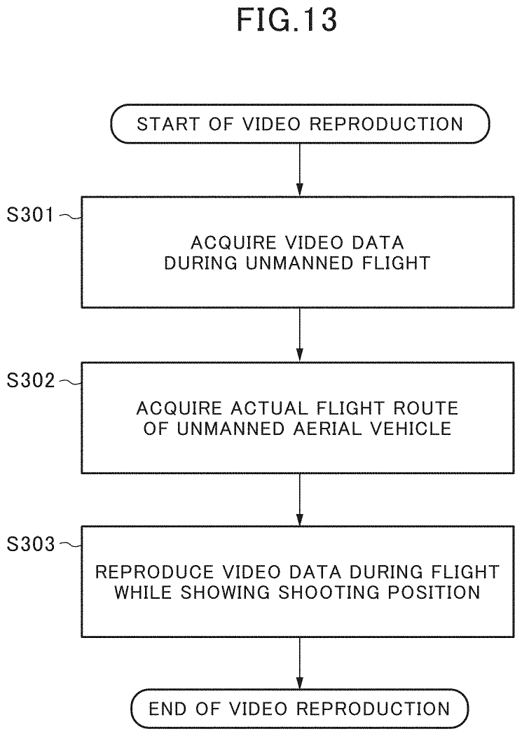

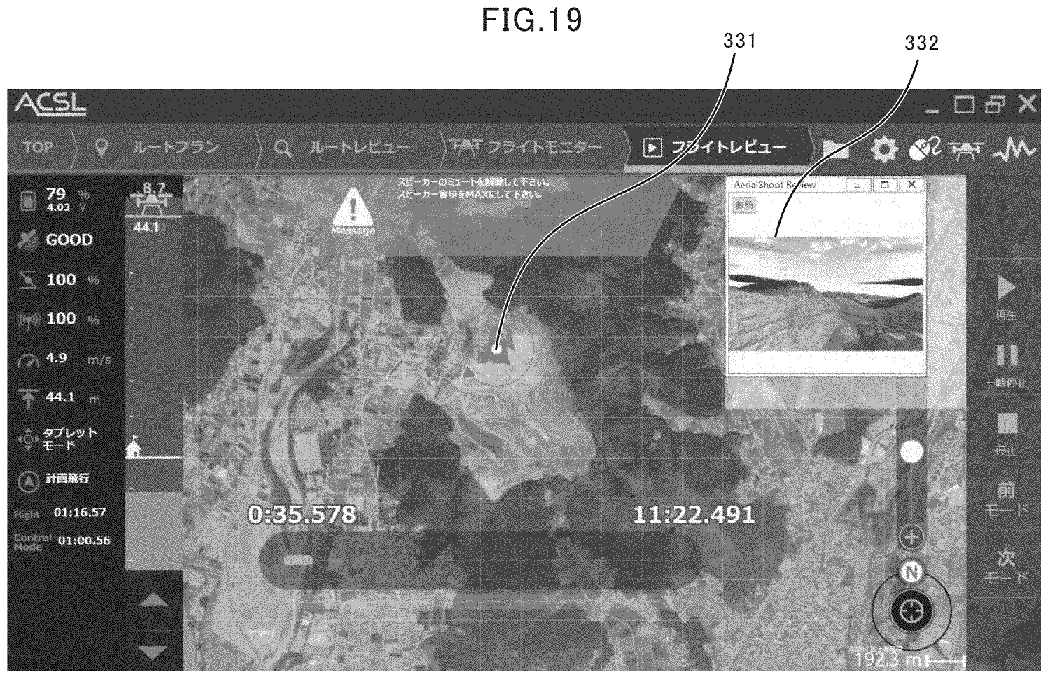

FIG. 13 is an operation flowchart at time of confirming an actual flight route of the unmanned aerial vehicle, in the flight plan route setting system 100. The video data reproduction module 110m7 acquires data on a video of an external scene during the unmanned flight shot by the video camera 206 of the unmanned aerial vehicle 200 (step S301). Specifically, data on a video of an external scene during the flight shot by the unmanned aerial vehicle 200 during the flight by using the video camera 206 and stored as the video data 110d3 is received by the flight plan route setting system 100 via the communication circuit or the like after completion of the flight and stored as the video data 110d3, and the video data reproduction module 110m7 acquires the data on the video from the video data 110d3. Next, the video data reproduction module 110m7 acquires data on an actual flight route of the unmanned aerial vehicle 200 (step S302). Specifically, the telemetry data transmitted during the flight by the unmanned aerial vehicle 200 via the communication circuit or the like is received by the flight plan route setting system 100 and stored as the flight log data 110d1, and the video data reproduction module 110m7 acquires the telemetry data from the flight log data 110d1. Next, the video data reproduction module 110m7 reproduces the data on the video of the external scene while showing positions at which the video was shot by the unmanned aerial vehicle 200 (step S303). The video data reproduction module 110m7 displays the video by reproducing the video data, and at the same time, identifies shooting positions at times of day when the video was shot from the flight log data 110d1, and displays the shooting positions in the flight area. Thus, the data on the video of the external scene during the flight shot by the unmanned aerial vehicle 200 is acquired, the data on the actual flight route of the unmanned aerial vehicle 200 is acquired, and the data on the video of the external scene can be reproduced while the positions at which the video was shot by the unmanned aerial vehicle 200 are shown. Note that it is also possible to make a configuration such that the data on the video of the external scene during the flight and flight positions are acquired in real time during the flight, and the data on the video is reproduced while the shooting positions are shown. In such a case, in step S203, the flight plan route setting system 100 may be configured to display the current position of the unmanned aerial vehicle 200 and the numerical values of the telemetry data in real time based on the received telemetry data, and in step S204, the unmanned aerial vehicle 200 may be configured to transmit the video data 210d3 to the flight plan route setting system 100 during the flight, and the flight plan route setting system 100 may be configured to receive the video data 210d3 and display the video in real time. FIG. 19 is an image view of a screen in which video data is reproduced while a shooting position is shown. In FIG. 19, a video 332 is reproduced and displayed, and at the same time, a shooting position 331 of the unmanned aerial vehicle 200 at a time when the video was shot is displayed on a photomap. Thus, it is possible that a shot video is confirmed while an actual shooting position is confirmed on a photomap or the like.

### INDUSTRIAL APPLICABILITY

The present invention can be used to set and confirm a flight plan route of any unmanned aerial vehicle for any of uses such as logistics, agriculture, and aerial photography, and to confirm a flight log.

### REFERENCE SIGNS LIST

100 flight plan route setting system
110 information processing section
110c main computation circuit
110p1 flight plan route setting program
110p2 flight review program
110p3 geographic information 3D display program
110d1 flight plan route data
110d2 flight log data
110d3 video data
110m1 horizontal-plane position data input module
110m2 height reference value input module
110m3 flight plan route altitude determination module
110m4 proximate place identification module
110m5 flight plan route correction module
110m6 geographic information 3D display module
110m7 video data reproduction module
111 network interface (IF)
112 external interface (IF)
150 database server
160 information processing section
161 geographic database
162 structure shape database
163 network interface (IF)
160c main computation circuit
160p data provision program
161 geographic database
162 structure shape database
200 unmanned aerial vehicle
201 control unit
202 motor
203 rotor
206 video camera
207 sensor
209 antenna
210 information processing unit
210c main computation circuit
210p flight control program
210d1 flight plan route data
210d2 flight log data
210d3 video data
211 communication circuit
212 control signal generation section
213 speed controller

1. A system for setting a 3D flight plan route of an unmanned aerial vehicle, the system comprising:
a horizontal-plane position data input section that inputs data indicating a scheduled flight route of the unmanned aerial vehicle on a horizontal plane as horizontal-plane data on the flight plan route;
a height reference value input section that acquires a height reference value indicating an elevation of a surface under each of a plurality of positions on the flight plan route; and
a flight plan route altitude determination section that determines values obtained by adding flight altitudes corresponding to the positions to the height reference values, respectively, as altitude data on the flight plan route.

2. The system according to claim 1, wherein the height reference value input section acquires an elevation of a ground surface under each of the plurality of positions on the flight plan route in the horizontal plane as the height reference value by reading from a geographic database.

3. The system according to claim 1, wherein the height reference value input section acquires an altitude of a floor surface inside a building under each of the plurality of positions on the flight plan route in the horizontal plane as the height reference value by reading from a structure shape database.

4. The system according to claim 2, further comprising a proximate place identification section that identifies, on any entity on the ground surface, a proximate place at which a distance from the flight plan route is equal to or less than a predetermined safe distance.

5. The system according to claim 4, wherein the proximate place identification section further outputs a distance and an orientation from a position on the flight plan route corresponding to the identified proximate place to the identified proximate place.

6. The system according to claim 4, wherein the proximate place identification section issues a warning when the proximate place is identified.

7. The system according to claim 4, further comprising a flight plan route correction section that, when the proximate place is identified by the proximate place identification section, corrects the flight plan route such that the proximate place is avoided.

8. The system according to claim 7, wherein when the proximate place is identified by the proximate place identification section, the flight plan route correction section automatically corrects the flight plan route such that a distance between the flight plan route and the proximate place becomes the safe distance or greater.

9. The system according to claim 7, wherein when the proximate place is identified by the proximate place identification section, the flight plan route correction section corrects the flight plan route such that the proximate place is circumvented on the horizontal plane.

10. The system according to claim 7, wherein when the proximate place is identified by the proximate place identification section, the flight plan route correction section corrects the flight plan route such that the proximate place is avoided above the proximate place.

11. The system according to claim 10, wherein if the flight plan route exceeds a predetermined altitude limit when an attempt is made to avoid the proximate place above the proximate place, the flight plan route correction section corrects the flight plan route such that the proximate place is circumvented on the horizontal plane so as to prevent the flight plan route from exceeding the predetermined altitude limit.

12. The system according to claim 4, wherein the proximate place identification section
reads an altitude above ground level of a structure existing under the flight plan route from a structure shape database, and
identifies, on the structure, a place at which an altitude difference obtained by subtracting the altitude above ground level of the structure from an altitude above ground level of a portion of the flight plan route above the structure is equal to or less than the predetermined safe distance, as the proximate place.

13. The system according to claim 12, wherein when the proximate place identification section reads the altitude above ground level of the structure existing under the flight plan route from the structure shape database, the proximate place identification section widens the flight plan route based on a predetermined width and reads the altitude above ground level of the structure existing under the flight plan route from the structure shape database.

14. The system according to claim 4, further comprising a 3D display section that causes the flight plan route to be three-dimensionally displayed in a screen.

15. The system according to claim 14, wherein the 3D display section causes the proximate place to be further displayed in a superimposed manner.

16. The system according to claim 14, further comprising a video data reproduction section that acquires data on a video of an external scene during a flight shot by the unmanned aerial vehicle, acquires data on an actual flight route of the unmanned aerial vehicle, and reproduces the data on the video of the external scene while showing a position where the video is shot by the unmanned aerial vehicle.

17. A computer program that implements the system according to claim 1 when the computer program is executed by a computer.
